(19) United States
(12) Patent Application Publication
(10) Pub. No.: US 2003/0066071 A1
(43) Pub. Date: Apr. 3, 2003

(54) Program recommendation method and system utilizing a viewing history of commercials

(75) Inventors: Srinivas Gutta, Yorktown Heights, NY (US); Kaushal Kurapati, Yorktown Heights, NY (US); Mi-Suen Lee, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/970,247

(22) Filed: Oct. 3, 2001

(51) Int. Cl. H04N 7/16; H04H 9/00; H04N 7/025; H04N 7/10

(52) U.S. Cl. 725/10; 725/12; 725/35; 725/34

(57) ABSTRACT

A program commercial based recommendation system employing a program commercial detection module, a facial estimation module, and a program recommendation module for implementing method for developing a viewing history of a viewer is disclosed. The program commercial detection module detects commercials within a transmission signal. In response to a detection of a program commercial, the facial estimation module generates a facial estimation of a viewer to thereby determine if the viewer is watching or not watching the program commercial. In response to a generation of the facial estimation, the program recommendation module stores the program commercial within a viewing history database. The stored commercial either has a positive rating when the facial estimation indicates the viewer is watching the program commercial or a negative rating when the facial estimation indicates the viewer is not watching the program commercial.

### BACKGROUND OF THE INVENTION

1. Field of the Invention

The present invention relates to systems that employ an electronic program guide to assist a media viewer in managing a large number of media-content choices (e.g., television programming, chatrooms, on-demand video media files, audio, etc.). The present invention more specifically relates to systems having the “intelligence” to suggest choices to a viewer and to take actions based on the suggestions (e.g., record a program on behalf of the viewer).

2. Description of the Related Art

As the number of channels available to television viewers has increased, along with the diversity of the programming content available on such channels, it has become increasingly challenging for television viewers to identify television programs of interest. Historically, television viewers identified television programs of interest by analyzing printed television program guides. Typically, such printed television program guides contained grids listing the available television programs by time and date, channel and title. As the number of television programs has increased, the ability to effectively identify desirable television programs using such printed guides has become impractical.

More recently, television program guides have become available in an electronic format, often referred to as electronic program guides (EPGs). Like printed television program guides, EPGs contain grids listing the available television programs by time, date, channel and title. An EPG, however, allows television viewers to sort or search the available television programs in accordance with personalized preferences. In addition, EPGs allow for on-screen presentation of the available television programs.

While EPGs allow viewers to identify several desirable programs more efficiently than conventional printed guides, they suffer from a number of limitations, which if overcome, could further enhance the ability of viewers to identify desirable programs. For example, many viewers have a particular preference towards, or bias against, certain categories of programming, such as action-based programs, or sports programming. Thus, the viewer preferences can be applied to the EPG to obtain a set of recommended programs that may be of interest to a particular viewer.

The ultimate goal in the design of a television program recommendation program is to achieve the best possible profile of a viewer. Thus, a viewing history of programs by the viewer is continually developed to enable a development of the viewer profile. However, prior to the present invention, a viewing history of commercials by the viewer was never utilized in developing the viewer profile.

### SUMMARY OF THE INVENTION

The present invention provides a recommendation of a program based, partially or completely, upon a viewing history of commercials. Various aspects of the invention are novel, non-obvious, and provide various advantages. While the actual nature of the present invention covered herein can only be determined with reference to the claims appended hereto, certain features, which are characteristic of the embodiments disclosed herein, are described briefly as follows.

One form of the present invention is a method for providing a program commercial based recommendation of a program. First, a program commercial within a transmission signal is detected. Second, a facial estimation of the viewer of the transmission signal is generated. And, third, the program commercial having a positive rating or a negative rating in response to a generation of the facial estimation is stored within a database.

A second form of the present invention is a computer system for providing a program commercial based recommendation of a program. A first module of the system is operable to detect a program commercial within a transmission signal. A second module of the system is operable to generate a facial estimation of a viewer of the transmission signal. And, a third module of the system is operable to store the program commercial having a positive rating or a negative rating within a database in response to a generation of the facial estimation.

A third form of the present invention is a computer program product in a computer readable medium for providing a program commercial based recommendation of a program. The computer program product includes computer readable code for detecting a program commercial within a transmission signal, computer readable code for generating a facial estimation of a viewer of the transmission signal, and computer readable code for storing the program commercial having a positive rating or a negative rating within a database in response to a generation of the facial estimation.

The foregoing forms and other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates a schematic diagram of one embodiment in accordance with the present invention of an automated recommendation system;

FIG. 2 illustrates a block diagram of one embodiment in accordance with the present invention of a computer of the FIG. 1 system; and

FIG. 3 illustrates a flow chart of a program commercial based recommendation routine in accordance with the present invention.

### DETAILED DESCRIPTION OF THE PRESENTLY PREFERRED EMBODIMENTS

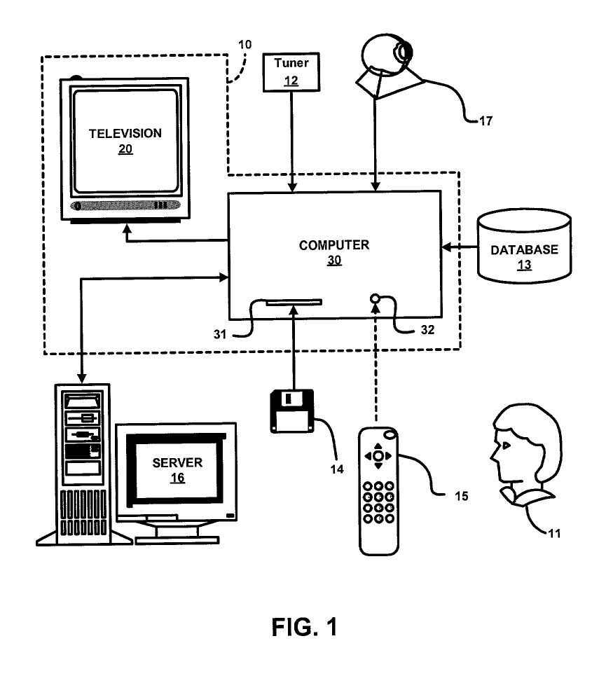

FIG. 1 illustrates an automated program recommendation system 10 for a viewer 11. System 10 comprises a display device in the form of a conventional television 20 as well a computer 30. Computer 30 can be housed within television 20 or set apart from television 20 as shown.

In the illustrated embodiment, computer 30 is equipped to receive program schedule data (e.g., an electronic program guide) from a server 16. Computer 30 can optionally receive feedback profile data, implicit profile data, and/or explicit profile data of other system 10 viewers from server 16. Computer 30 is further equipped to receive a video signal including program schedule data from a tuner 12 (e.g., a cable tuner or a satellite tuner). Computer 30 is also equipped with an infrared port 32 to allow viewer 11 to select a program to be viewed via a remote control 15. For example, viewer 11 can utilize remote control 15 to highlight a desired selection from an electronic program guide displayed on television 20. Computer 30 can have access to a database 13 from which computer 30 can receive updated program schedule data. The access can be accomplished by a telephone line connectable to an Internet service provider or some other suitable data connection. Computer 30 is further equipped with a disk drive 31 to upload program schedule data, profile data of viewer 11, and profile data of other system 10 viewers via a removable media such as a disk 14.

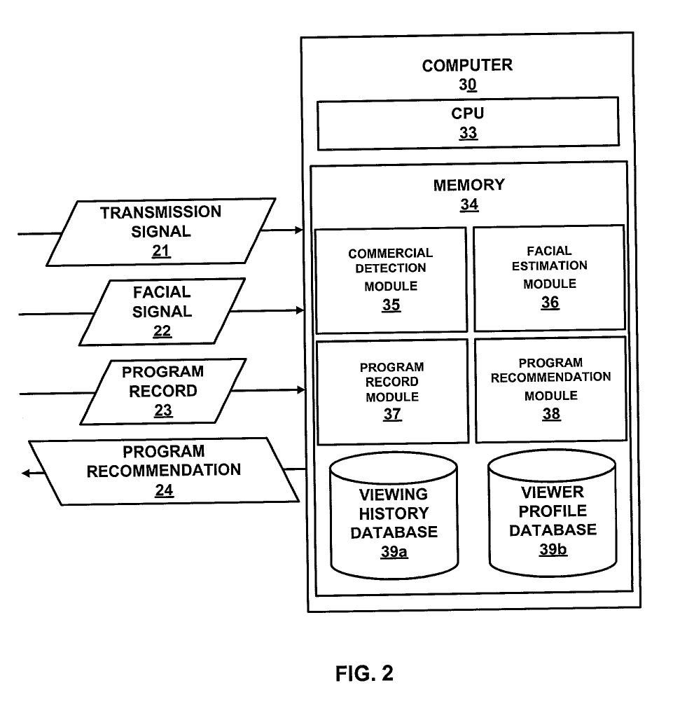

A conventional digital camera 17 is connected to computer 30 to provide a facial signal 22 thereto as will be described in more detail in connection with FIG. 2. The digital camera 17 can be positioned anywhere in a room by user 11 whereby a line of sight of digital camera 17 encompasses a viewing area of viewer 11. Alternatively, digital camera 17 can be housed within the casing of computer 30 with computer 30 being positioned anywhere in a room by user 11 whereby the line of sight of digital camera 17 encompasses the viewing area of viewer 11. Also, additional digital cameras 17 can be employed within system 10.

Computer 30 may be configured in any form for accepting structured inputs, processing the inputs in accordance with prescribed rules, and outputting the processing results to thereby control the display of television 20 as would occur to those having ordinary skill in the art. Computer 30 may therefore be comprised of digital circuitry, analog circuitry, or both. Also, computer 30 may therefore be programmable, a dedicated state machine, or a hybrid combination of programmable and dedicated hardware.

FIG. 2 illustrates one embodiment of computer 30. In the illustrated embodiment, computer 30 includes a central processing unit (CPU) 33 operatively coupled to a solid-state memory 34. CPU 33 can be from the Intel family of microprocessors, the Motorola family of microprocessors, or any other type of commercially available microprocessor. Memory 34 is a computer readable medium (e.g., a read-only memory, an erasable read-only memory, a random access memory, a compact disk, a floppy disk, a hard disk drive, and other known forms) that is electrically, magnetically, optically or chemically altered to contain computer readable code corresponding to a program commercial detection module 35, a facial estimation module 36, a program record module 37, and a program recommendation module 38. Additionally, memory 34 stores a viewing history database 39a of viewer 11 (FIG. 1), and a viewer profile database 39b of viewer 11. To execute the computer readable code within memory 34, computer 30 can additionally include any control clocks, interfaces, signal conditioners, filters, Analog-to-Digital (A/D) converters, Digital-to-Analog (D/A) converters, communication ports, or other types of operators as would occur to those having ordinary skill in the art.

In alternative embodiments of computer 30, program record module 37, commercial detection module 35, facial estimation module 36, program record module 37, and program recommendation module 38 can be partially or fully implemented with digital circuitry, analog circuitry, or both (e.g., an application specific integrated circuit).

In response to a reception of a transmission signal 21 in real time, CPU 33 controls a method for developing viewing history database 39a based, partially or completely, upon a detection and viewing of a program commercial by viewer 11.

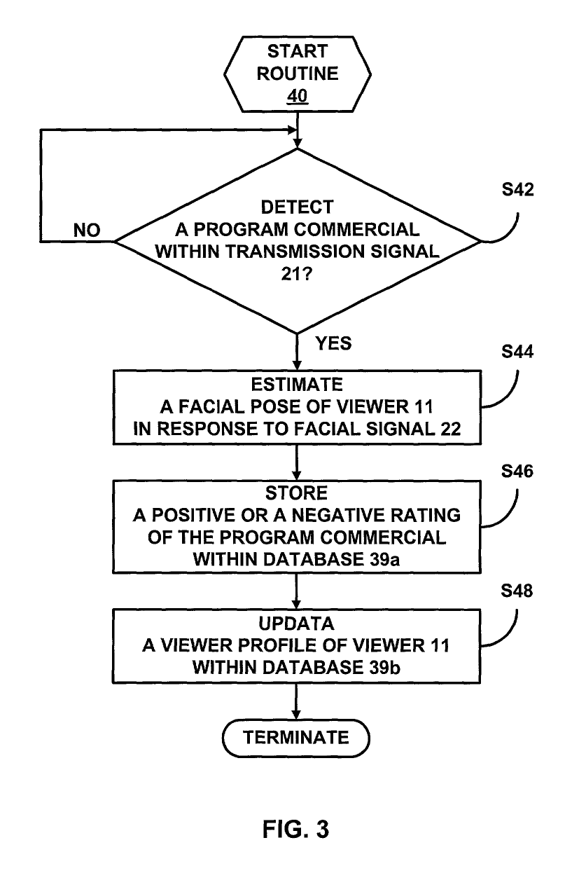

FIG. 3 illustrates a routine 40 for implementing the program commercial based program recommendation method of the present invention. In the illustrated embodiment, during a stage S42 of routine 40, CPU 33 controls an execution of commercial detection module 35 to determine when a program commercial (i.e., a program commercial advertising a future program) is within transmission signal 21. In one embodiment, commercial detection module 35 is designed in accordance with the principles of U.S. patent application Ser. No. 09/945,871 filed Sep. 4, 2001, entitled “METHOD OF USING TRANSCRIPT INFORMATION TO IDENTIFY AND LEARN COMMERCIAL PORTIONS OF A PROGRAM”, the entirety of which is hereby incorporated by reference and is assigned to the assignee of the present invention. Accordingly, commercial detection module 35 additionally provides data indicative of various features of the detected program commercial (e.g., genre, TV rating, station, etc.)

Upon a detection of a program commercial within transmission signal 21, during a stage S44 of routine 40, CPU 33 controls an execution of facial estimation module 36 in estimating a facial pose of viewer 11 in response to facial signal 22 from digital camera 17 (FIG. 1). In one embodiment, facial signal 22 supplies an image of a head of viewer 11, and facial estimation module 36 transforms the image to generate a window of white, gray and black pixels forming the head of viewer 11 based on a pattern recognition technique as known in the art, such as, for example, a statistical technique, a syntactical technique, a neural technique, and an entropy analysis involving non-parametric probability estimators. Facial estimation module 36 thereafter attempts to recognize an outer corner of either eye within the pixels to thereby determine if viewer 11 is watching the detected program commercial. A facial estimation indicating viewer 11 is watching or not watching the detected program commercial is then generated by facial estimation module 36.

Upon a generation of the facial estimation, during a stage S46 of routine 40, CPU 33 controls an execution of program recommendation module 38 in storing the detected program commercial and corresponding features within viewing history database 39a. The detected program commercial is also stored with either a positive rating when the facial estimation indicates viewer 11 was watching the detected program commercial, or a negative rating when the facial estimation indicates viewer 11 was watching the detected program commercial. Program recommendation module 38 can be one of many prior art programs for providing a recommendation based upon the well-established theory of concept learning. In one embodiment, program recommendation module 38 is a decision tree classifier disclosed in U.S. patent application Ser. No. 09/466,406, filed Dec. 17,1999, and entitled “METHOD AND APPARATUS FOR RECOMMENDING TELEVISION PROGRAMMING USING DECISION TREES”, hereby incorporated herein by reference and assigned to the assignee of the present application. In a second embodiment, program recommendation module 38 is Bayesian classifier disclosed in U.S. patent application Ser. No. 09/498,271, filed Feb. 4, 2000, and entitled “BAYESIAN TV PROGRAM RECOMMENDER”, the entirety of which is hereby incorporated herein by reference and assigned to the assignee of the present application. In a third environment, program recommendation module 38 is a nearest neighbor classifier disclosed in U.S. patent application Ser. No. 09/975,594, filed Jun. 6, 2001 and entitled “NEAREST NEIGHBOR RECOMMENDATION METHOD AND SYSTEM”, the entirety of which is hereby incorporated herein by reference and assigned to the assignee of the present application.

Upon a storage of the detected program commercial within viewing history database 39a, during a stage S48 of routine 40, CPU 33 controls an execution of program recommendation module 38 in updating viewer profile database 39b. In one embodiment, viewing history database 39a only stores program commercials. Viewer profile database 39b therefore stores various features directed to only stored program commercials. In a second embodiment, viewing history database 39a stores programs viewed or not viewed by viewer 11 in addition to the program commercials. Viewer profile database 39b therefore stores various features directed to programs and program commercial.

Routine 40 returns to stage S42 upon an update of viewer profile database 39b.

In response to program record 23, CPU 33 controls an execution of program record module 37 for conventionally processing program record 23. CPU 33 controls an execution of program recommendation module 38 in generating a program recommendation 24 of a program corresponding to program record 23 that utilizes viewer profile database 39b. Thus, the generated recommendation is based, partially or completely, upon a history of detected commercials within viewing history database 39a.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

We claim:

1. A method for providing a program commercial based recommendation of a program, said method comprising:
detecting a program commercial within a transmission signal;
generating a facial estimation of the viewer of the transmission signal; and
storing the program commercial having a positive rating or a negative rating within a viewing history database in response to a generation of the facial estimation.

2. The method of claim 1, further comprising:
updating a profile of the viewer within a viewer profile database in response to a storage of the program commercial within the viewing history database.

3. The method of claim 1, further comprising:
generating a recommendation of the program from the profile of the viewer.

4. A computer system for providing a program commercial based recommendation of a program, said computer system comprising:
a program commercial detection module operable to detect a program commercial within a transmission signal;
a facial estimation module operable to generate a facial estimation of the viewer of the transmission signal; and
a program recommendation module operable to store the program commercial having a positive rating or a negative rating within a viewing history database in response to a generation of the facial estimation.

5. The computer system of claim 4, wherein:
said program recommendation module is further operable to update a profile of the viewer within a viewer profile database in response to a storage of the program commercial within the viewing history database.

6. The computer system of claim 4, wherein:
said program recommendation module is further operable to generate a recommendation of a program from the profile of the viewer.

7. A computer program product in a computer readable medium for providing a program commercial based recommendation of a program, said computer program product comprising:
computer readable code for detecting a program commercial within a transmission signal;
computer readable code for generating a facial estimation of the viewer of the transmission signal; and
computer readable code for storing the program commercial having a positive rating or a negative rating within a viewing history database in response to a generation of the facial estimation.

8. The computer program product of claim 7, further comprising:
computer readable code for updating a profile of the viewer within a viewer profile database in response to a storage of the program commercial within the viewing history database.

9. The computer program product of claim 7, further comprising:
computer readable code for generating a recommendation of a program from the profile of the viewer.

10. A computer system for providing a program commercial based recommendation of a program, said computer system comprising:
means for detecting a program commercial within a transmission signal,
means for generating a facial estimation of the viewer of the transmission signal; and
means for storing the program commercial having a positive rating or a negative rating within a viewing history database in response to a generation of the facial estimation.

11. The computer system of claim 10, further comprising:
means for updating a profile of the viewer within a viewer profile database in response to a storage of the program commercial within the viewing history database.

12. The computer system of claim 11, further comprising:
means for generating a recommendation of a program from the profile of the viewer.
